(19) United States
(12) Patent Application Publication
(10) Pub. No.: US 2003/0101251 A1
(43) Pub. Date: May 29, 2003

(54) Customizable element management system and method using element modeling and protocol adapters

(75) Inventor: Keng Min Low, Addison, TX (US)

Correspondence Address: Duke W. Yee, Carstens, Yee & Cahoon, LLP, P.O. Box 802334, Dallas, TX, 75380, US

(73) Assignee: Varros Telecom, Addison, TX (US)

(21) Appl. No.: 10/040,119

(22) Filed: Jan. 2, 2002

Related U.S. Application Data
(60) Provisional application No. 60/334,176, filed on Nov. 27, 2001.

(51) Int. Cl. G06F 15/173

(52) U.S. Cl. 709/223

(57) ABSTRACT

A customizable element management system and method are provided. The system and method provide a flexible and customizable element management system (EMS) through the use of Universal Modeling Language (UML) models for each of the elements of the EMS. A library of base information models are provided for various application network services, network equipment, equipment adapters, and the like. Customized versions of these base information models may be generated by simply modifying one or more components of the base information model and incorporating any business logic into the base information model. The customized models may then be “plugged into” the EMS framework after having incorporated an appropriate adapter for handling translation of native protocols to an EMS standardized framework protocol.

### RELATED APPLICATION

The present application is related to, and claims the benefit of priority, of co-pending provisional U.S. Patent Application Serial No. 60/334,176 entitled “Customizable Element Management System and Method Using Element Modeling and Protocol Adapters,” filed on Nov. 27, 2001, which is hereby incorporated by reference in its entirety.

### BACKGROUND OF THE INVENTION

1. Technical Field

The present invention is directed to an improved data processing system. More specifically, the present invention is directed to an improved element management system in which elements are modeled and coupled to an element management system framework through protocol adapters in order to make the element management system highly customizable.

2. Description of Related Art

Element management systems (EMSs), such as the Cisco 6700 Series, Cisco 8100 EMS, Cisco IAD1100 Series EMS, Nokia LoopMaster EM10 EMS, Coriolis Optiview EMS, etc., are typically used to monitor and manage network elements in a data processing network. These EMSs, however, are specific to a particular use. That is, the business logic, network architecture, and presentations, e.g. graphical user interfaces, are specifically developed for a particular use and are closely tied to one another.

However, in real world applications it is desirable to change the network elements themselves, the business logic associated with the network elements, and the manner by which users wish to view information about network elements, from time to time. Therefore, it is often necessary to change the way in which the EMS operates. Because of the close arrangement of business logic, network architecture and presentation, the known EMSs tend to be inflexible to such changes requiring a complete redesign of the EMS in order to implement a change.

Such changes, if able to be made, require a high level or knowledge on the part of the designer with regard to the manner by which the equipment in the network operates and the way in which the EMS operates. In addition, due to the inflexibility of the EMS, a great deal of time and effort must be expended to customize the EMS to a new business logic, architecture or presentation.

What is needed is a more flexible EMS architecture that lends itself to customizability. It would be beneficial to have an element management system and method through which business logic and presentation are separated and through which network elements may be easily customizable.

### SUMMARY OF THE INVENTION

The present invention provides a customizable element management system and method. The present invention provides a flexible and customizable element management system (EMS) through the use of Universal Modeling Language (UML) models for each of the elements of the EMS. A library of base information models is provided for various application network services, network equipment, equipment adapters, and the like.

Customized versions of these base information models may be generated by simply modifying one or more components of the base information model and incorporating any business logic into the base information model. The customized models may then be “plugged into” the EMS framework after having incorporated an appropriate adapter for handling translation of native protocols to a common framework protocol used by all subsystems of the EMS.

In order to plug the customized equipment model into the EMS framework, a data channel is generated for the equipment model. The data channel serves to separate the equipment specific behavior from the business logic. Components of the data channel may publish sets of events specific to the component. Other data channels for other equipment in the network may choose to support any or all of those events. The logic that goes into supporting any event may be implemented differently in each individual data channel. However, the application network services (ANSs) do not need to know anything about the specific implementation in each data channel. Rather, the ANS need only subscribe to these events published by the data channel. When the event is delivered to the ANS, the payload of the event is self describing and easily digested by the ANS. This allows the ANS to fully deal with all aspects of an event without having to contend with the complexities of dealing with specific network element types.

Thus, by customizing a base information model, generating a data channel and an adapter, and incorporating the data channel and adapter into the customized base information model, a new or modified network element may be easily incorporated into a network architecture and modeled using an EMS according to the present invention. Because the business logic and the equipment specific behavior are separated by the use of customized data channels, the equipment specific behavior and/or business logic may be modified independent of the other.

In addition to the above, the present invention provides a mechanism by which presentation screens may be defined using a drag-and-drop visual builder environment. The presentation screens may be defined independently of the implementations of the various equipment models in the EMS.

Using a drag-and-drop visual builder, a XML/UIL file is generated and sent to a Java rendering engine. The Java rendering engine renders a User Interface Screen based on the XML/UIL file, all with no custom handcrafted code—only the XML/UIL file data. The Java rendering engine can render any presentation screen as long as the XML/UIL file contains supported and syntactically correct XML constructs supported by the rendering engine. The XML file basically instructs the rendering engine to instantiate Java beans. User interactions for supporting the dynamic behaviour of a graphical interface screen can also be specified as part of the XML/UIL file.

Thus, customized presentations may be easily generated without having to modify the underlying EMS framework or the equipment models. Moreover, different presentations may be generated for the same data. These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A is an exemplary block diagram illustrating a known methodology for creating an element management system (EMS);

FIG. 1B is an exemplary diagram illustrating a methodology according to the present invention for creating an EMS;

FIG. 2 is an exemplary diagram illustrating a model generation tool according to the present invention;

FIG. 3 is an exemplary block diagram of an EMS according to the present invention;

FIG. 4 is a diagram illustrating an EMS data channel according to the present invention;

FIG. 5 is a diagram illustrating an application layer according to the present invention;

FIG. 6 is a diagram illustrating a presentation layer according to the present invention;

FIG. 7 is a flowchart outlining an exemplary operation for adding or modifying a network element model in an EMS;

FIG. 8 is a flowchart outlining an exemplary operation for customizing a network element model;

FIG. 9 is a flowchart outlining an exemplary operation for generating a data channel and adapter for plugging in the customized network element model into the EMS framework;

FIGS. 10-27 illustrate screen shots of graphical user interfaces (GUIs) of an EMS element generation tool according to the present invention;

FIG. 28 is an exemplary block diagram of a client device according to the present invention;

FIGS. 29-33 illustrate various display views generated using Java beans according to the present invention; and

FIG. 34 is an exemplary diagram illustrating the manner by which a view is displayed to a user and a user may generate events through the displayed view.

### DETAILED DESCRIPTION OF THE PREFERRED EMBODIMENT

The present invention provides an element management system (EMS) and method in which the customization of the EMS to particular fields of use is made easy and timely through the use of element modeling and protocol adapters for connecting the element models to a core EMS framework and through the separation of the business logic from the presentation layer in the EMS.

With the present invention, elements are modeled in the EMS by modifying parameters of pre-generated “base” models. These modified models are then connected to a core EMS framework through adapters which provide a translation from an element communication protocol to a standard communication protocol used by the core EMS framework. A data channel model is generated for the modified models, through which the modified models communicate with other elements of the EMS. This allows for quick and easy customization of the network elements in the EMS data processing network managed by the EMS. Thus, changes to the actual network architecture may be quickly and easily modeled in the EMS by the present invention.

In addition, the present invention provides a mechanism for separating the business logic of the EMS from the presentation, i.e. graphical user interfaces, of the EMS. Because the business logic is separated from the presentation layer, changes to the presentation layer may be made without requiring changes to the EMS framework or network element models. The business logic remains intact while the graphical user interfaces may be customized by the individual user.

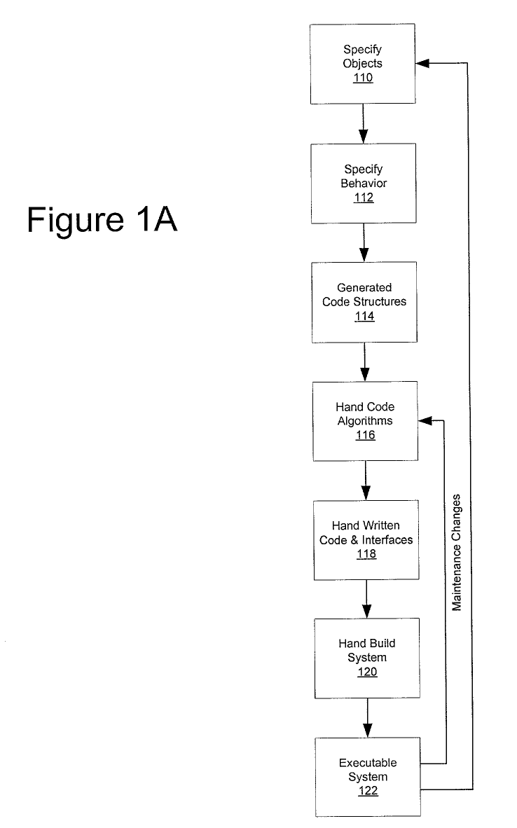

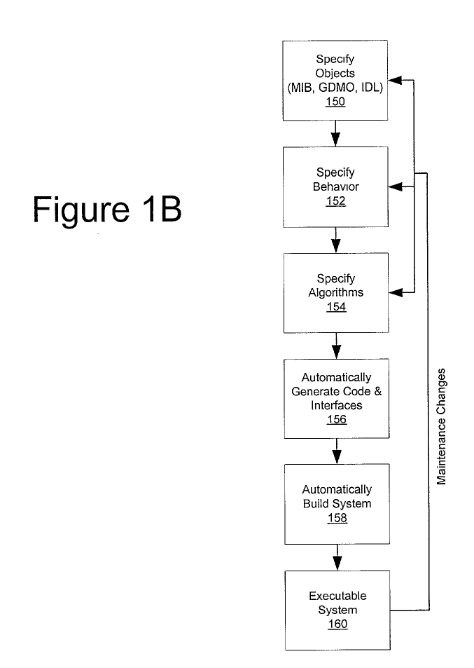

FIG. 1A is an exemplary diagram illustrating a prior art methodology for generating an element management system (EMS). As shown in FIG. 1A, the typical EMS development cycle starts with the specification of network objects (110). Then the behavior of the network objects is specified (112). The specified objects and behavior generate code structures (114) that are provided to human programmers that generate code algorithms by hand (116). The hand written code and interfaces (118) generated by the human programmers are then provided to human network architecture experts that hand build the resulting EMS (120) and an executable EMS (122) is obtained.

Any maintenance changes require the human programmers to hand code the changes and provide them to the human network experts for implementation into the executable EMS. Any changes to the EMS itself must be made by going through this entire process again. Each part of the operation is tightly intertwined. If the Management Information Base (MIB), i.e. the code describing a network object, is changed in the known EMS, for example, the server must also be changed. If the server is changed, the graphical user interface (GUI) must also be changed, and so on. It is clear, that the result is a very inflexible and rigid element management system that does not lend itself to customizability.

FIG. 1B is an exemplary diagram illustrating a methodology for generating an EMS according to the present invention. As shown in FIG. 1B, as with the prior art approach, the methodology involves specifying the network objects (150) and specifying their behavior (152). The algorithms of the EMS are specified in an action language (154) which is used to automatically generate code and interfaces (156). The generated code and interfaces are then used to automatically build the EMS (158) and generate an executable system (160).

Any changes to the EMS may be made to respective ones of the network objects, the object behaviors, or the algorithms independently. That is, if the change to the EMS involves only a modification to an algorithm, only the algorithm need be modified. If the change involves a different object behavior, only the object behavior need be modified. The other elements of the EMS will operate on the modified element without a need for modification themselves. The modified element may then be used, through the automatic code generation and system build, to generate a modified executable EMS.

Thus, the present invention reduces the amount of required human interaction in the generation of code, interfaces, and the executable system. The human programmer need only specify objects, behavior and algorithms and does not need to have a detailed knowledge of how to generate the code, interfaces, and executable system. This greatly reduces the amount of time required to customize and deploy an EMS. This also provides a flexible EMS that may evolve to add new services, interfaces, etc.

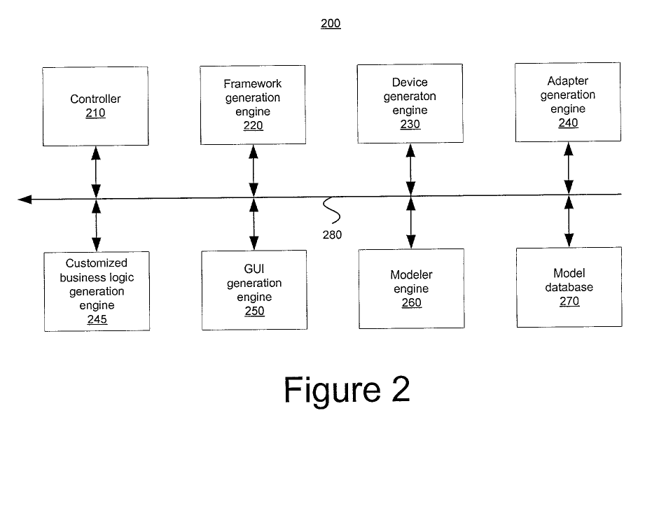

In order to specify the objects, the object behavior, and the algorithms, a number of tools are provided by the present invention. FIG. 2 illustrates an EMS element generation tool according to the present invention. As shown in FIG. 2, the EMS element generation tool 200 is comprised of a controller 210, a framework generation module 220, a network element generation module 230, an adapter generation module 240, a customized business logic generation module 245, a graphical user interface generation module 250, a modeler 260, and a model database 270. These elements are coupled to one another via the control/data signal bus 280. Although a bus architecture is shown in FIG. 2, the present invention is not limited to such and any architecture in which communication between the elements 210-270 may be used without departing from the spirit and scope of the present invention.

The controller 210 controls the overall operation of the present invention and orchestrates the operation of the other components 220-270. The controller 210 invokes the operation of the other components 220-270 and controls the flow of data along the control/data signal bus 280.

The framework generation module 220 and network element generation module 230 make use of the modeler 260 for modeling and customizing new framework services, network devices, data channels, graphical user interfaces (GUIs), and the like. The modeler 260 may make use of base information models stored in the model database 270.

A base information model is a standard model that may be customized based on the particular framework service, network device, data channel, etc., that is being implemented in the element management system. These base information models may include, for example, the Management information base (MIB) of existing equipment. Alternatively, a service, device, data channel, etc. may have its base information model completely generated using the features of the present invention.

With a preferred embodiment of the present invention, models are defined using the Unified Modeling Language (UML). UML is an object-oriented analysis and design language from the Object Management Group (OMG). UML standardizes several diagramming methods and supports nine kinds of diagrams including use case diagramming, sequence diagramming, collaboration diagramming, class diagramming, and state charts. Although UML is used in the preferred embodiment of the present invention, other modeling languages may be used without departing from the spirit and scope of the present invention.

Customized models may be developed to support new classes of network equipment, services, adapters, etc., by modifying components within the base information models. For example, a base UML router model may be provided that supports components that are specific to router activities. However, equipment vendors may differ in the way these router activities are performed. A customized model is generated by modifying the base model's components, e.g., the components of a base “router” model based on the requirements of the vendor specific equipment, and adding support for any enterprise specific Management Information Bases (MIBs) of the vendor specific equipment.

In a similar manner, services and adapters may be generated using base information models. The components of base UML models may be modified for both services and adapters to generate a new class of services and adapters. In this way, all equipment, services, and adapters in the EMS are represented as UML models.

The generation of customized network element models, e.g., equipment models, by the network element generation module 230, involves first starting with a common or base information model, such as an SNMP information model, i.e. a MIB, a TL1 information model, a Q3 information model, or the like, obtained from the model database 270 or other storage device. These information models are then converted to an Extensible Markup Language/Network Model Information (XML/NMI) model by the modeler 260 which takes the information model and compiles it into an XML/NMI instance file. The XML/NMI instance file is the metadata which is needed by the generated element object. Information about the classes, the attributes, and the properties of the XML/NMI instance are all extracted and automatically created as metadata in the XML/NMI instance file by the modeler engine 260 of the present invention.

The present invention strives to be as data-driven as possible such that changes can be affected, in many cases, by merely changing the data and thus, the objects themselves do not need to be regenerated. Take for example a pricing/sales application. The application does not change but the database and its components change. The XML/NMI instance file is, for example, the database and the objects are the applications.

The present invention makes use of a conversion application in the modeler 260 that converts the information model into an XML/NMI instance file. Each type of information model may have a different syntax. SNMP MIB's and CMIP's GDMO, for example, have completely different syntax. They, however, convey information about the management capabilities of the network element. CMIP is Object Oriented (OO)-based, so the GDMO conveys information about the objects, its attributes of the objects, inheritance, relationships and associations. SNMP's MIB is not OO-based but rather very RDBMS-like. It too describes the management capabilities but in terms of tables and columns. Invariably programmers objectify the MIB by relating a table to a class and its columns to attributes.

The conversion application is provided with rules regarding the structure and corresponding syntax of the information model. The conversion application takes these rules and generates a XML/NMI instance file based on a mapping of the information model structure and syntax to the XML/NMI schema. For example, SNMP tables may be mapped to classes. Once the information model is converted by the modeler 260 into an XML/NMI instance file, what is obtained is an object, its attributes, and its attribute properties including its OID values.

Once the base XML/NMI instance of the information model is obtained, i.e. the equipment object, the XML/NMI instance is customized based on the requirements for the function of the equipment, the deployment scenarios, the relationships with other network element models, e.g. equipment objects, and the like, as ascertained by the human designer. These aspects of the XML/NMI instance file are typically not captured by the information model. The present invention models these aspects and thus captures them in the XML/NMI instance file which is then used by the network element objects.

For example, consider an aspect of the XML/NMI instance file called Audit. Every network management application requires that an audit be done (i.e. which objects and what attributes in that object need to retrieved to sync-up the application and the network element). However, the actual audit performed is specific for each network element. The present invention models this relationship so that the Audit application retrieves the data for the particular implementation of the Audit for that particular network element from XML/NMI instance file and performs the audit with no code changes to the actual Audit application.

By customization of the XML/NMI base model, what is meant is that the human designer modifies the base XML/NMI instance to designate the relationships that are specific to the equipment being modeled, e.g., containment, naming, dependencies, auditing information, traps (severity attribute, severity level), physical attributes, and the like. That is, after having performed a conversion of the information model to obtain an XML/NMI instance file, the human designer is permitted, through the use of a text editor, or the like, to modify the XML/NMI instance file such that it represents a customized version of the XML/NMI instance file.

One feature of the present invention is that the equipment traps, i.e. error messages that are sent by an equipment element indicating a problem with the element, are handled as metadata which the Fault Manager ANS then implements as a metadata base. This allows for traps having a varying number of attributes because the metadata does not limit the number of fields in a trap table entry, as with traditional trap handling. Note that all traps from all network equipment may now be generically handled with no changes to the Fault Manager ANS.

After modification by the human designer, the equipment model is now available. Next, it is necessary to implement the model in the EMS. To do this, a data channel and protocol adapter are generated to define the way in which the equipment model operates and communicates in the network. The data channel is generated from a base data channel model that most closely matches the functionality and features of the customized equipment model. The base data channel model is customized by modifying the business logic, for example, based on the functionality of the customized equipment model.

For example, a router is just a router and the business logic of a router remains the same regardless of the manufacturer, especially if the manufacturer follows standards guidelines. From the management perspective then, it is a question of merely having to understand what the manufacturer is doing different to provide the same router functions. Just like every coffee maker makes coffee, however it is necessary to know whether the coffee maker is a 4-cup, 12-cup or automatic timer. A router always provides routing information but the way to get the routing information may be different. This is where the business logic comes into play. That is, the business logic defines the way the equipment functions and thus, the business logic of the base data channel model may be modified to define the way in which the equipment modeled by the equipment model communicates with and functions in the network.

Each of these base data channel models implement an identical interface so that higher level applications, such as ANSs, need not know which type/vendor/version of the data channel and equipment model the applications are communicating with. Consider routers from Cisco, Hewlett Packard, and 3COM. Traditionally, the EMS needs to be aware of the particular type of router that is being used in order for the EMS to operate properly. With the present invention, however, the router class exposes an interface, i.e. an interaction, to retrieve all routes. Each data channel implements that interface in a different way for the specific manufacturer's equipment, as defined by the customized business logic of the data channel. In this way, higher level applications, e.g., route managers and path managers, do not have to know about how routes are maintained and stored in a particular manufacturer's router. Thus, the present invention separates out the business logic from the mechanisms for performing the functions of the equipment.

Next, a gateway, i.e. a protocol adapter, is generated for the new equipment model. This protocol adapter is generated by the adapter generation module 240 from predefined adapter packages stored in an adapter database (not shown). These adapter packages are defined for conversion between a native protocol data message and a standard EMS protocol data message, such as an XML/NMI protocol message.

In order to generate the adapter for this particular equipment model, all that is necessary is for the adapter generation module 240 to determine the messaging protocol used by the equipment and to add the proper adapter package to the equipment model. Thus, for example, if the equipment model is for an SNMP-based router, all that is necessary is to add the SNMP adapter packet to the router equipment model and it will immediately know how to build and receive SNMP package data units while taking care of all marshalling, encoding, message handling, etc.

At this point, the equipment model includes the objects and the behavior of the equipment. In order to better be able to manage the equipment, customized business logic may be provided in the equipment model. The customized business logic generation module 245 may be used to provide this customized business logic and automatically generate executable business logic code within the equipment model.

The customized business logic generation module 245 makes use of Action Language (which is defined by the OMG standard). Action Language is described in the OMG standard available at http://www.omg.org/techprocess/meetings/schedule/Action_Semantics_for_UML_RFP.html. The Action Language allows the business logic to be defined in terms of business rules having objects, operations, events and state changes. Once these business rules are defined using the Action Language, the code for the business rules is automatically generated from the Action Language using a compilation program for compiling the Action Language into executable code.

At this point, the equipment model comprises the objects (obtained from the selection and customization of an information model), their behavior (obtained from the selection of and customization of a data channel and adapter), and the algorithms (obtained from the specification of business rules using the Action Language). The equipment model is then compiled into executable code to thereby generate an equipment engine.

The equipment engine may then be plugged into an application software bus in the EMS framework. The equipment engine is plugged into the application software bus by starting up the equipment engine and initializing it so that it is running in conjunction with the EMS framework and other engines. Once plugged into the application software bus, the equipment engine becomes available to all the other engines and any other clients through any other adapters that are coupled to the application software bus. The new equipment is now completely supported by the EMS.

The framework generation module 220 is used to generate the framework services that will exist in the application layer of the EMS between a presentation software bus and an application software bus. These framework services are referred to as core application network services (ANSs). A core ANS is a service that may be used by equipment coupled to the EMS framework. ANSs collectively provide support for common element and network management services such as network topology/discovery, equipment inventory and configuration, fault management and correlation, performance monitoring and management, and the like.

Every ANS is a collection of active software components that follow the same design principles: extensibility, scalability, and flexibility. In order to generate a core ANS from a base model ANS, the designer need only concentrate on the business logic of the components of the existing base UML models to effortlessly plug-in the new component, via a services manager, which is another ANS that dynamically advertises the component public and related services. A public service is accessible by all ANS on the application bus while related services are accessible to components in the same ANS.

Each core ANS itself supports a set of published events where each event may support a variety of delivery and reception characteristics. Events are how each ANS communicates internally with its other components and externally with other ANS. Events are also how data channels of equipment engines communicate with ANSs and other data channels.

An event may contain a payload, which may be one or more XML/NMI packets, for example. The payload is self-describing, i.e. provides sufficient information about itself that the ANS or other service accessing the payload need not know a priori the nature of the payload. Therefore, the ANS that subscribes to the event and receives the event, may process the event without having to know the details of how a data channel component implements its support of the event. That is, the specific implementation of the equipment engines is transparent to the ANS.

Each ANS may have multiple adapters to allow it to be on multiple data buses. For example, an ANS that supports graphical user interfaces (GUIs) may have a presentation bus adapter. This adapter would translate XML/NMI messages to Extensible Markup Language/User Interface Language (XML/UIL), for example, and also mediate between event-based services like core ANS and Simple Object Access Protocol (SOAP)-based protocols.

In addition, the core ANSs provide a new feature directed to application versioning. Installing an application is a multi-step process and updating an application while it is running is also not practical. These problems are alleviated by the present invention in that the component-based ANS is self-describing and self-contained. When an ANS is self-describing, it provides zero-impact installation and simplifies uninstall and replication. A self-describing ANS provides sufficient information about itself to fully install itself. When an ANS is self-contained, each component contains its own version and a comprehensive set of versions of all other components in that ANS, such that when combined, results in a correctly functioning ANS. A self-contained ANS is an ANS in which each component knows about itself and all its dependencies.

The core ANS support side-by-side components, which means that multiple versions of a component may be installed and supported by ANS. The component manager ANS will load and direct services to the appropriate component, allowing multiple versions of an ANS to be supported on the same deployment of the EMS.

Core ANS also enforce versioning and dependencies via the use of application manifests and version policies. A manifest is authored prior to deployment and each manifest is essentially a self-describing metadata of an ANS, containing a manifest identity, a list and version of all components, and any other referenced manifests. When the ANS is installed and deployed, the manifest is recorded with the system's version manager ANS. Using the version client and component manager of each ANS, the EMS can thus enforce the conditions necessary to run the ANS at run-time by ensuring that the correct version of a component is loaded.

Having generated the new equipment model and plugged it into the EMS framework via the adapters, data channel, and the application software bus, the graphical user interface (GUI) generation module 250 is utilized to generate presentation screens and link them to application network services (ANS) for monitoring and managing the new equipment engines. With a preferred embodiment of the present invention, the client devices used by administrators to view and manage the network via the EMS have Java-based rendering engines for rendering presentation screens defined by the present invention.

It should be noted that the protocol adapters of the present invention understand XML/NMI and can adapt any XML/NMI data to presentation Java beans which in turn understand XML/UIL data, i.e. the XML definition of the physical layout of the presentation screens. The Java beans may then be rendered by the Java-based rendering engines on the client devices. The XML/NMI file may also include Application Program Logic (APL) that implements the behavior of the screens.

Every action that the user can do using the presentation screens is captured as an event. That event is then passed to an application network service as specified by the APL of the XML/NMI file. Client devices do not make any decisions themselves. All data comes directly from the presentation screen and all actions are caught and handled by the application network services.

Since the presentation screens are separated from the data, a user may tailor the presentation screens according to their requirements without modifying any of the services. This allows the same application network services to be used with different presentation screens.

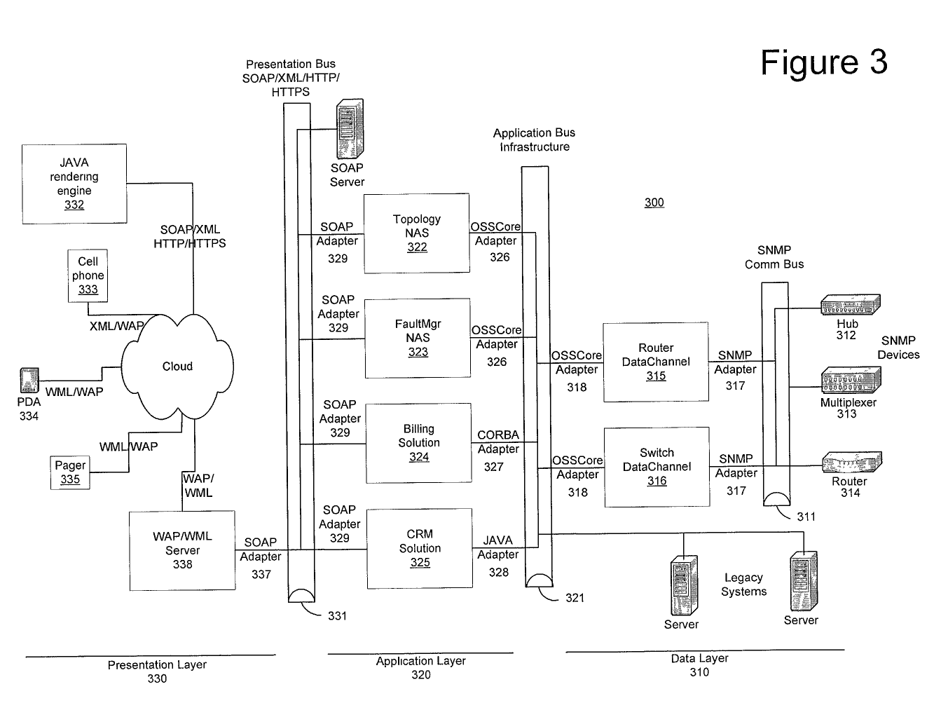

FIG. 3 is an exemplary diagram illustrating an EMS architecture according to the present invention. As shown in FIG. 3, the EMS 300 is comprised of a data layer 310, an application layer 320, and a presentation layer 330. These three layers operate independently of the other layers, as will be described in greater detail hereafter. Because of this independent operation, expansibility and customizability are enhanced through the use of the present invention.

The three layers 310, 320 and 330 center around the provision of three different software buses: an SNMP communication bus 311, an application bus 321 and a presentation bus 331. The protocols that run on these software buses are bus-dependent. In the exemplary embodiment, the SNMP communication bus utilizes SNMP, the application bus 321 uses an Open Source System Core (OSSCore) protocol, and the presentation bus 331 uses SOAP. The use of these particular protocols is not intended to limit the present invention but are only provided as part of an exemplary preferred embodiment. Other protocols may be used without departing from the spirit and scope of the present invention.

Just like hardware protocols, there must be adapters from one transport medium to another. The architecture of the present invention provides for software adapters 317, 318, 326, 327, 328, 329, and 337 such that an application can be plugged into any bus 311, 321 or 331. Adapters allow applications to quickly “plug-in” to the bus without affecting existing applications.

Adapters 329 and 337 plug into the presentation bus 330, the SNMP protocol adapters 317 plug into the SNMP bus 311, and OSSCore adapters 318, 326, Common Object Request Broker Architecture (CORBA) adapters 327, and JAVA adapters 328 plug into the application bus infrastructure 320. The adapters provide the mediation between a standard EMS protocol and the native protocols. That is, in the exemplary embodiment, the standard EMS protocol is Extensible Markup Language/Network Managed Information (XML/NMI) and the adapters mediate and transform native data representations into XML/NMI messages, and vice versa. The transformations may be generic using simple data mapping schemes like integers to strings, or the transformations may be specifically designed for an application.

The framework buses 311, 321 and 331 provide the transport medium for messages between the elements of the EMS. The XML/NMI protocol is the format of the data that flows along these buses. XML/NMI is an open, flexible language, based on the Extensible Markup Language, that provides a common language between elements in the EMS 300. The common language allows applications to have a shared definition of network information, e.g., topology, nodes, circuits, trunks, routes, alarms, physical equipment views, network address, bandwidth, etc. Applications describe their services using the XML/NMI language, which simplifies the interaction between the application interfaces, reduces cost and provides stability, as will be described in greater detail hereafter.

As shown in FIG. 3, the data layer 310 in this exemplary embodiment is based around the SNMP communication bus 311 through which SNMP devices 312-314 are coupled to data channels 315-316 of the EMS infrastructure. The data channels 315-316 are coupled to the SNMP communication bus 311 and the application bus infrastructure 321 via adapters 317 and 318. The adapters 317 provide protocol translation between the XML/NMI formatted data flowing across the SNMP communication bus 311 and the SNMP formatted data utilized by the SNMP devices 312-314 and data channels 315-316. The adapters 318 provide protocol translation between the SNMP formatted data from the data channels 315-316 and the XML/NMI formatted data flowing across application bus infrastructure 321. In addition, the legacy systems 319 may be coupled to the SNMP communication bus 311 via a legacy gateway.

The application layer 320 of the EMS 300 is comprised of a plurality of core application network service (ANS) engines 322-325 coupled to the application bus infrastructure 321 and the presentation bus 331 via adapters 329 and 337. The core ANSs subscribe to events published by the data channels 315-316 in the data layer and perform management of the network devices based on the payloads of the events subscribed to. In addition, the ANSs are used by client devices 332-335 in the presentation layer 330 to render presentation screens for view and manipulation by human users.

The presentation layer 330 is comprised of a presentation bus 331, one or more client devices 332-335, an adapter 337 coupled to a server 338 and the presentation bus 331. The presentation layer 330 further includes a server 339 on which customized presentations may be generated and stored for use with one or more of the client devices 332-335.

With the present invention, the data for use with the customized presentations is obtained from the application layer 320 and formatted into a customized presentation by way of presentation screens that are stored on the server 339. The users of client devices 332-335 may define customized screens using a drag-and-drop visual builder environment and use them with network management data obtained from the application layer 320.

Because the presentation screens are customized independently of the network element models, customized presentations may be quickly developed without requiring changes to the network element models. In the same way, network element models may be modified without having to modify the presentation screens. This allows for a flexible architecture in which the presentations may be changed often without requiring a redesign of the network architecture.

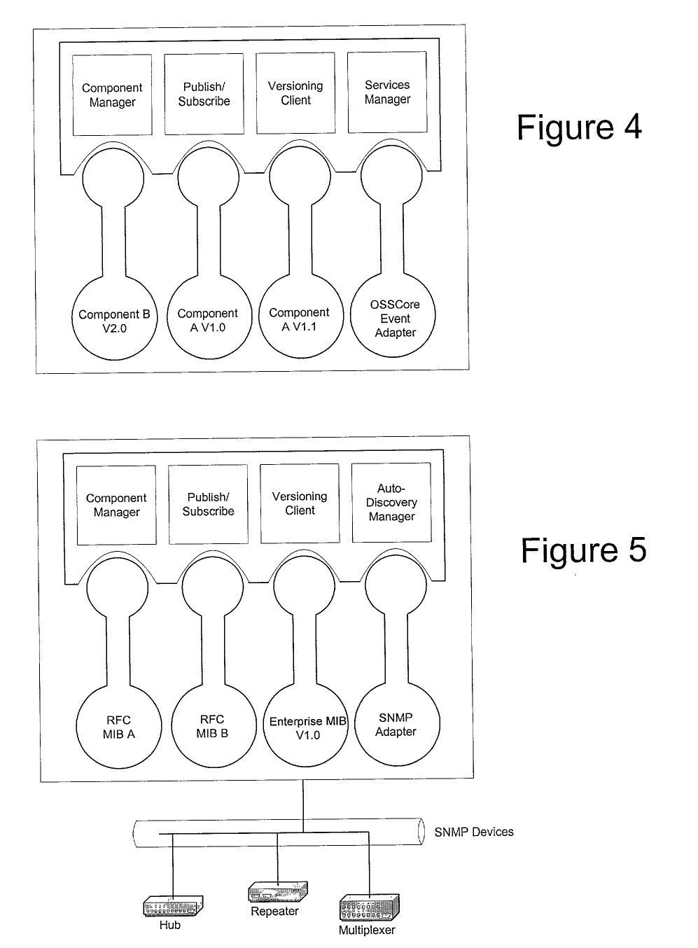

FIG. 4 is an exemplary diagram of the data channel in the data layer of an EMS according to the present invention. A data channel provides the abstraction and access to data sources, e.g., network equipment, legacy systems and other network management systems. A data channel is similar to an ANS with the exception that an ANS is comprised of services and a data channel is defined by a set of packages that describe the entity to be managed. The data channel can be thought of as an ANS which uses a SNMP adapter to plug into the SNMP bus and an OSSCore adapter to plug into the application bus infrastructure. The adapters mediate between XML/NMI messages and SNMP data. Similarly, data channels may be built for supporting other device protocols such as TL1, CMIP, CLI, etc. A data channel is built using the modeler to model equipment and a gateway to provide native protocol support.

As shown in FIG. 4, a typical data channel 400 includes a component manager 410, a publish/subscribe module 420, a versioning client module 430, and a services manager 440. Communication using the data channel 400 is performed via components 450-470 of the equipment model and events via the event adapter 480.

FIG. 5 illustrates an application layer in accordance with the present invention. As shown in FIG. 5, the application layer 500 includes a plurality of ANSs including a component manager ANS 510, a publish/subscribe module ANS 520, a versioning client module ANS 530, and an auto-discovery manager ANS 540. The equipment engines communicate with the application layer ANSs by way of RFC MIBs 550-560, enterprise MIB 570, and SNMP adapter 580.

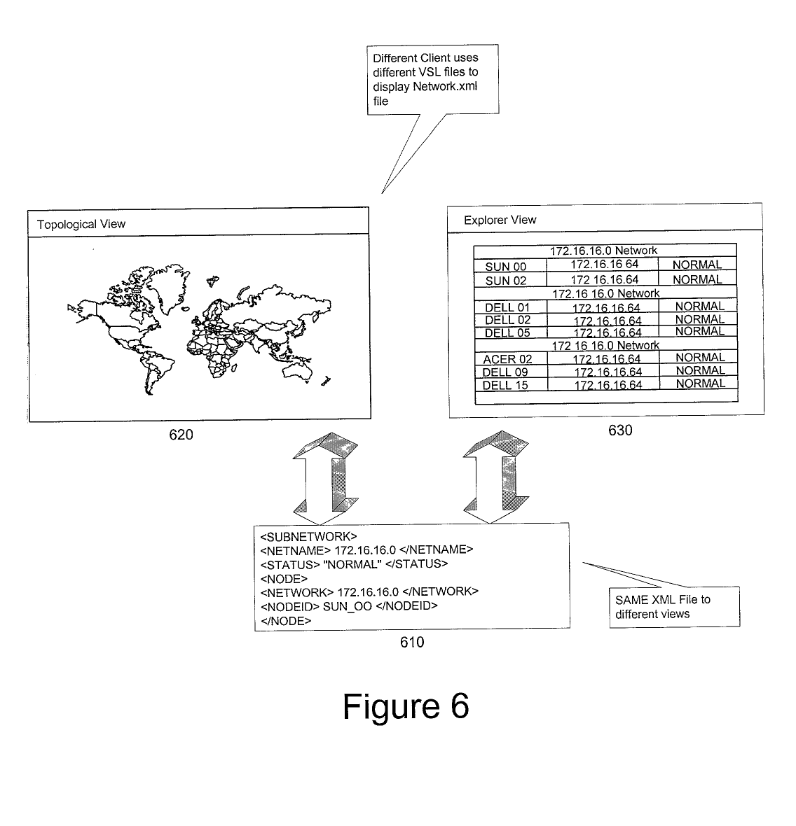

FIG. 6 illustrates how the presentation layer of the present invention may be used to define different customized screens for displaying the same network management data. As shown in FIG. 6, the same XML file 610 is utilized to generate two different displays 620 and 630. That is, the users of two different client devices, or the same client device, define two different screens using a drag-and-drop visual builder environment. Using a drag-and-drop visual builder, a XML/UIL file is generated and sent to a Java rendering engine. The Java rendering engine renders a User Interface Screen based on the XML/UIL file, all with no code—only the XML/UIL file data. The Java rendering engine can render any presentation screen as long as the XML/UIL file contains supported and syntactically correct XML constructs. The XML file basically instructs the rendering engine to instantiate Java beans. The XML file is used to instruct the rendering engine to instantiate a Java bean, place it, initialize it and capture all user events from the Java bean. User interactions are supported through the application program logic in the Java bean. Thus, simply by changing the XML/UIL data, a completely new and customized presentation may be generated. The generation of customized presentation views will be described in greater detail hereafter.

When the user retrieves the network management information from the application layer, the user designates which presentation screen is to be used to display the network management information. For example, one screen may display the network management information in terms of a topographical view and the other in terms of an explorer view.

Thus, with the present invention, the presentation layer is separated from the data layer. Thus, the same data may be used to generate different presentations. Furthermore, the user may designate new presentations without having to modify the data or application layers.

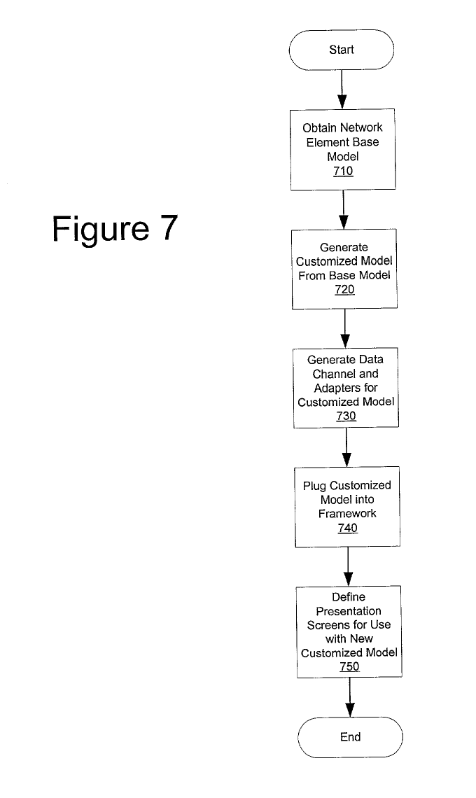

FIG. 7 is a flowchart illustrating an overall methodology for adding a new element, or modifying an existing element, in an EMS in accordance with the present invention. As shown in FIG. 7, the methodology starts with the obtaining a network element base model for the network element (step 710). The base model is then used to generate a customized network element model (step 720). A data channel and adapters are then generated for the customized network element model (step 730). The customized network element model is then plugged into a software bus of the EMS framework via the adapters and data channel (step 740). Thereafter, one or more customized presentation screens are defined for displaying network management information obtained from the customized network element model (step 750). This process may be repeated for each new network element model.

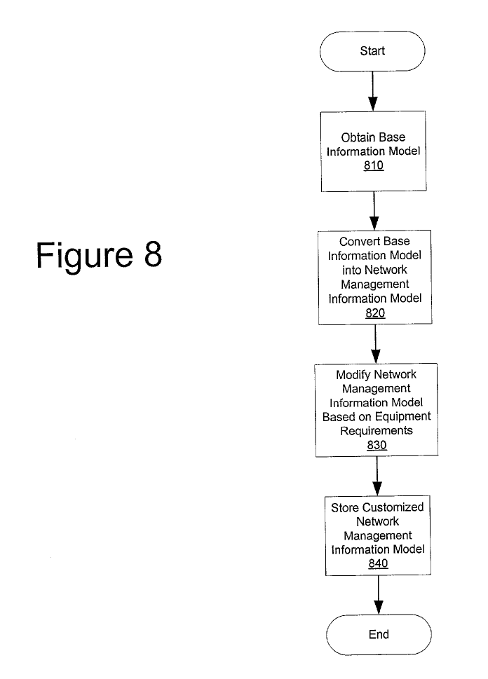

FIG. 8 is a flowchart outlining an exemplary operation for customizing a network element model using a base network element model in accordance with the present invention. As shown in FIG. 8, the operation starts with obtaining a base information model (step 810). Then, the base information model is converted to a network management information model (step 820). Thereafter, the network management information model is modified based on the requirements of the specific network element being modeled (step 830). The customized network management information model, i.e. the customized network element model, is then stored (step 840) and the operation ends.

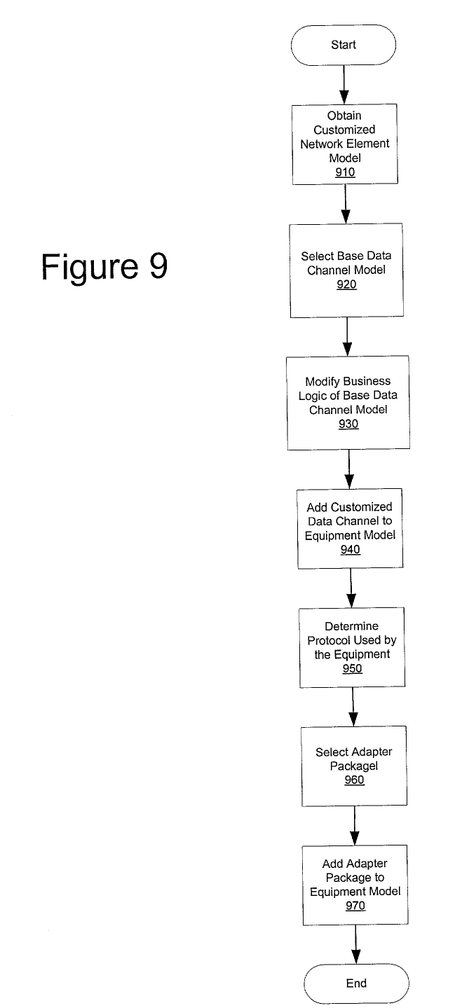

FIG. 9 is a flowchart outlining an exemplary operation for generating the data channel and adapters for the customized network element model in accordance with the present invention. As shown in FIG. 9, the operation starts with obtaining a customized network element model (step 910). A base data channel model is then selected that most closely represents the functionality of the customized network element model (step 920). The business logic of this base data channel model is then modified, if necessary, to customize it for use with the customized network element model (step 930). The customized data channel model is then added to the equipment model (step 940).

Next, the protocol used by the equipment is determined (step 950). Based on the protocol used by the equipment, an appropriate adapter package is selected from a plurality of predefined adapter packages (step 960). The adapter package is then added to the equipment model (step 970) and the operation ends.

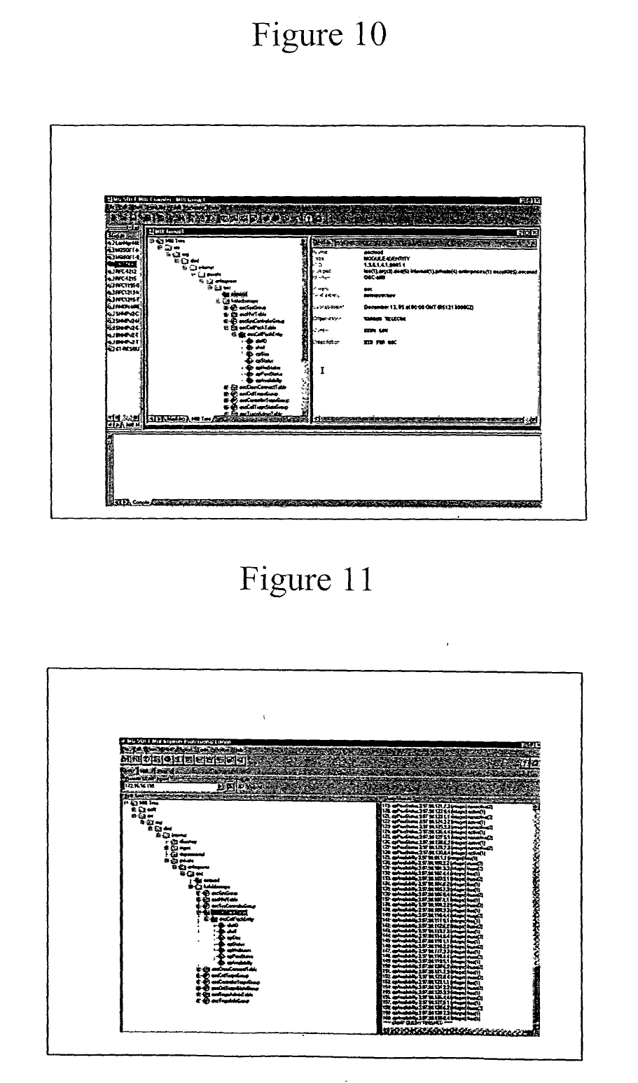

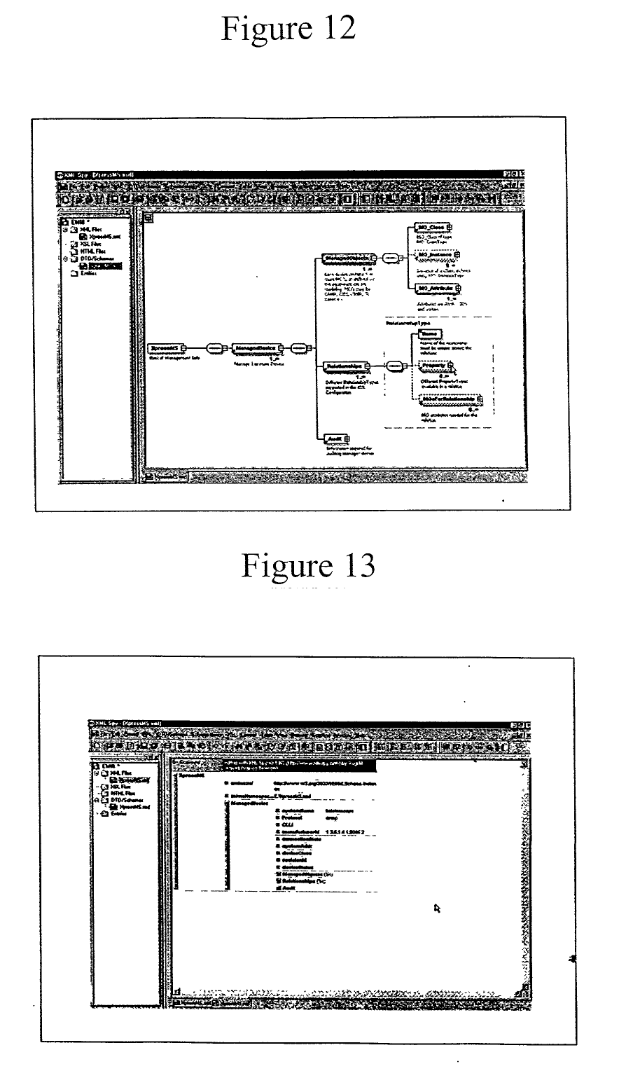

FIGS. 10-27 illustrate screen shots of graphical user interfaces (GUIs) of an EMS element generation tool according to the present invention. FIG. 10 illustrates a GUI for the selection of a base information model. FIG. 11 illustrates a GUI for gathering requirements for the new equipment. FIG. 12 illustrates a GUI for converting the base information model into an XML/NMI model.

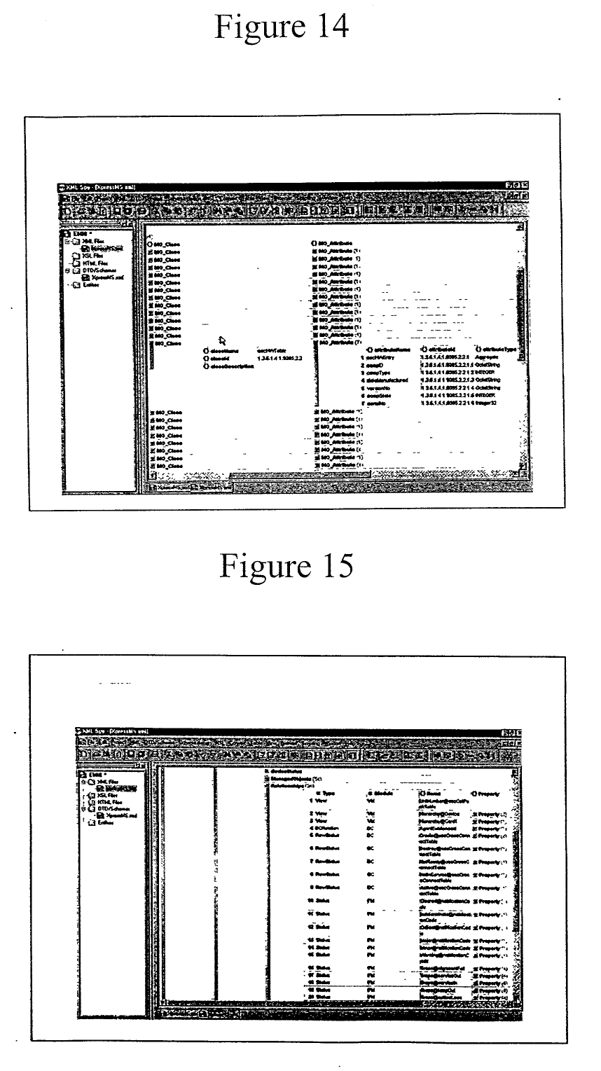

FIG. 13 illustrates a GUI for running of the base information model through a compiler which generates an XML/NMI file from the base information model. FIG. 14 illustrates a GUI for displaying the resulting XML/NMI file obtained from the compiler. FIG. 15 illustrates a GUI for modifying the components of the generated XML/NMI file in order to customize the XML/NMI to the particular network equipment that is to be modeled in the EMS.

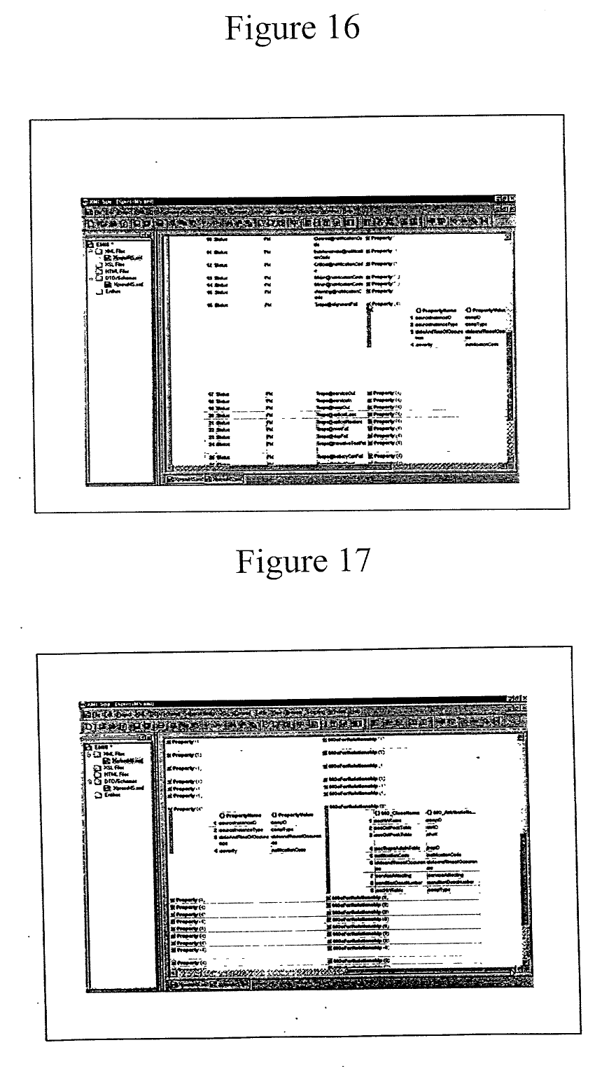

FIG. 16 illustrates a GUI in which trap relationships are displayed and where these trap relationships may be manipulated in order to customize the operation of the traps to the particular network equipment functions. FIG. 17 illustrates a GUI that illustrates the handling of traps as metadata.

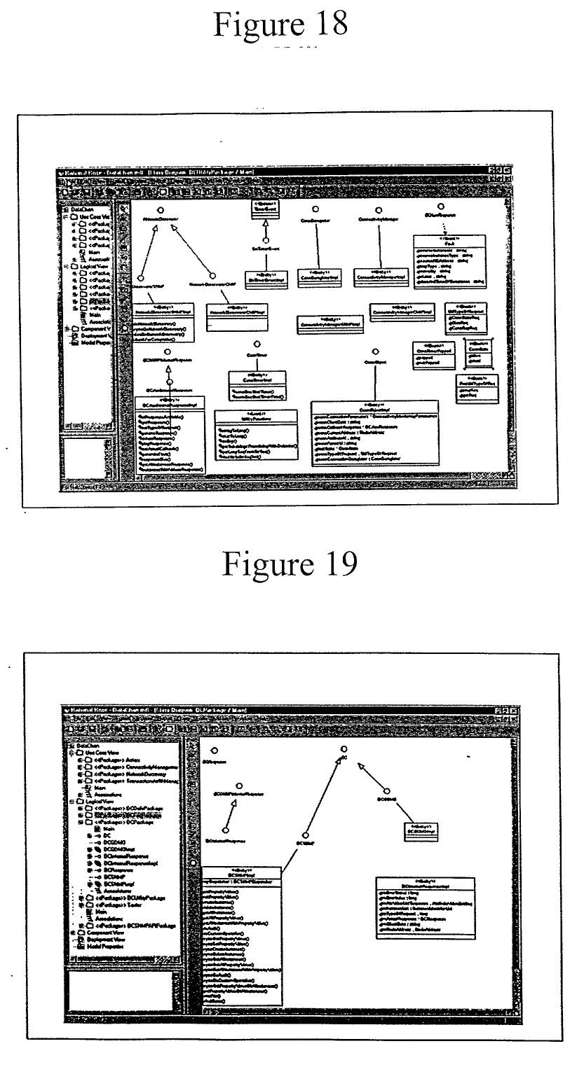

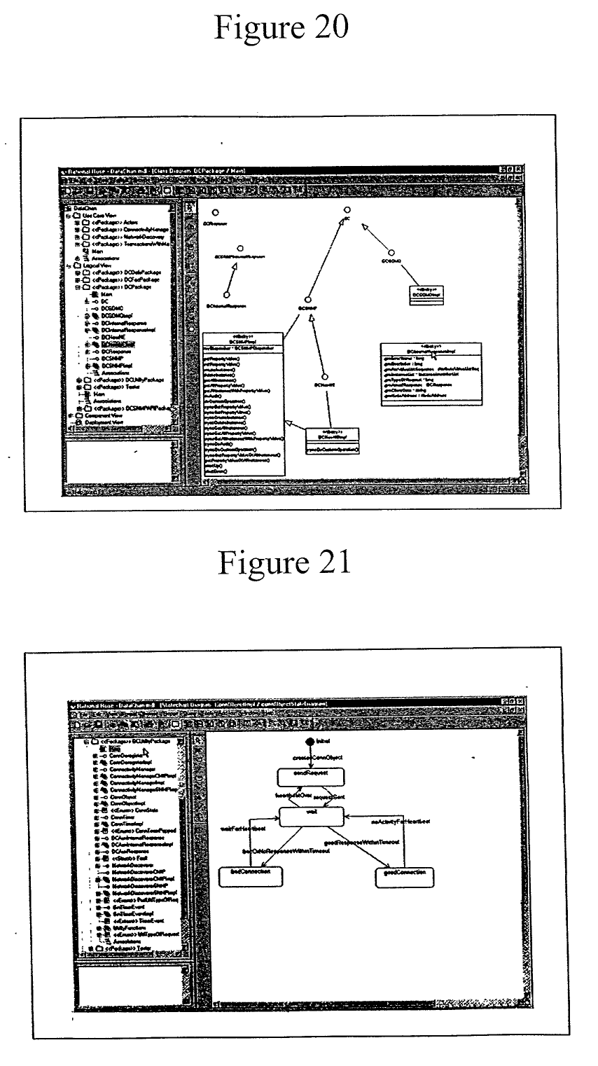

FIG. 18 illustrates a GUI for generating a data channel model. FIGS. 19 and 20 illustrate GUIs for customizing a base data channel model based on the protocol of the equipment and the particular functionality of the equipment.

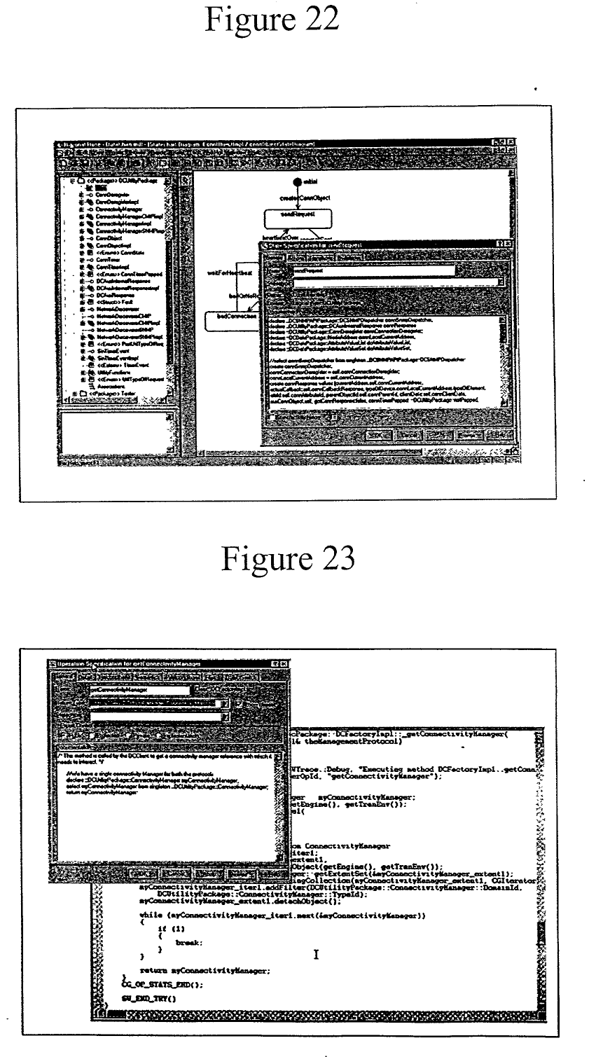

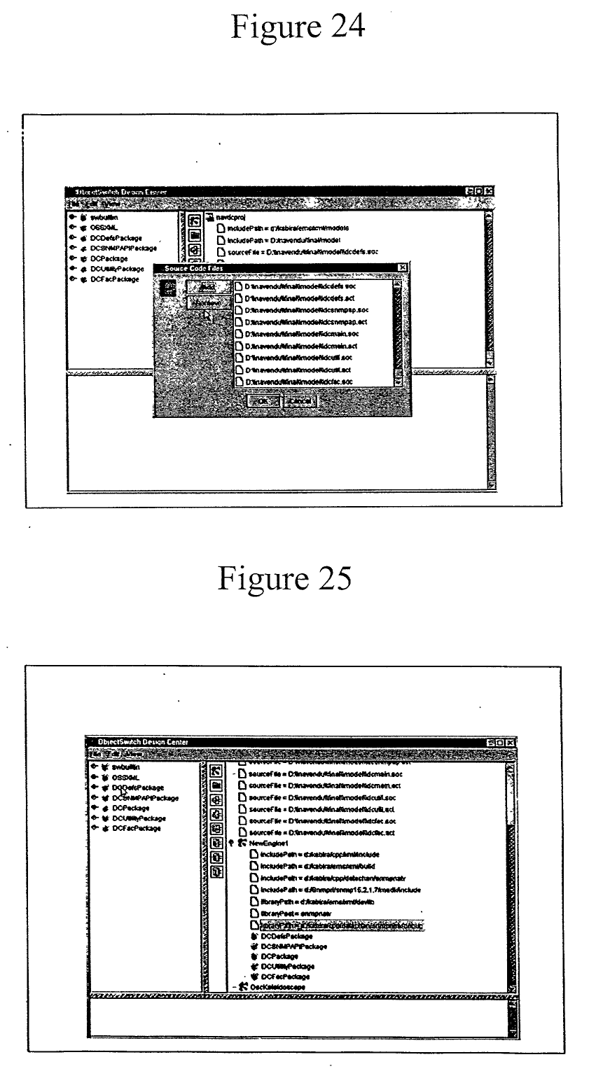

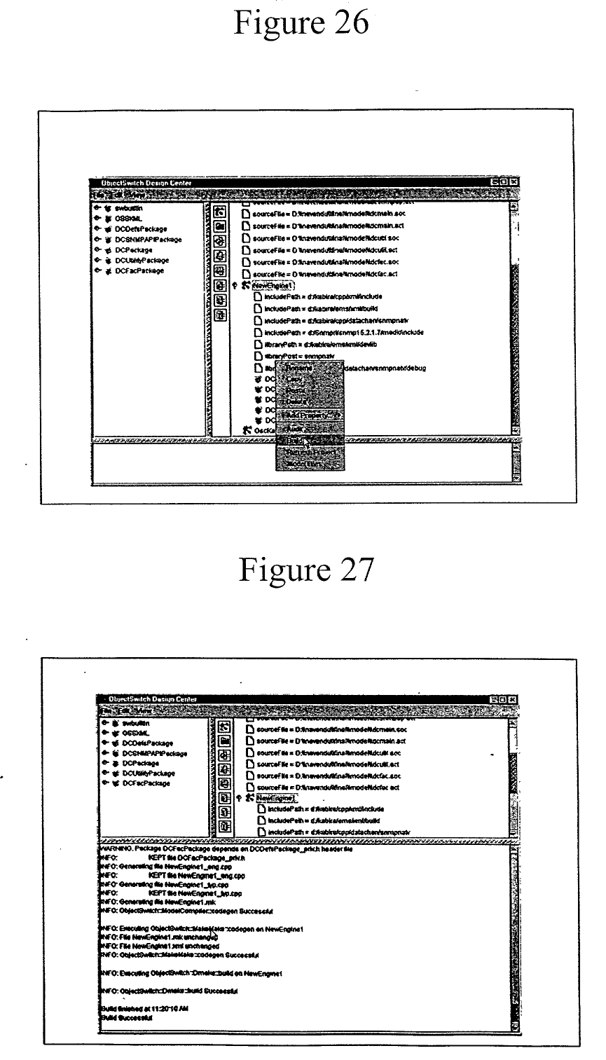

FIG. 21 illustrates a GUI for customizing business logic using Action Language. FIGS. 22 and 23 illustrate GUIs in which the code generated by the Action Language is depicted. FIG. 24 illustrates a GUI for adding the new equipment engine to a database of equipment engines. FIG. 25 illustrates a GUI for displaying the engines in the database. FIG. 26 illustrates a GUI for building the equipment engine for use with the EMS. FIG. 27 illustrates a GUI depicting the equipment engine as part of the EMS.

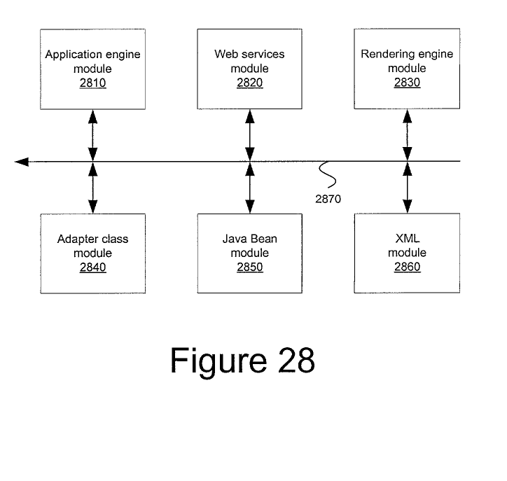

FIG. 28 illustrates a client device according to the present invention. The client device is utilized by, for example, a human administrator of the network and is a device that aids the human administrator in determining the state of a network based on information obtained from the EMS. As shown in FIG. 28, the client device includes an application engine module 2810, a web services module 2820, a rendering engine module 2830, an adapter class module 2840, a Java Bean module 2850, and an XML module 2860 in addition to other standard computing device components including one or more processors, communication interfaces, and the like. These elements are coupled to one another via the communication interface 2870.

The application engine module 2810 is the central part of the client architecture and is responsible for coordinating with all the modules 2820-2860. The application engine module 2810 is also responsible for handling events. The application engine module 2810 coordinates with the web services module 2820 to obtain the data to be displayed. The application engine module 2810 coordinates with the rendering engine module 2830 to obtain the information about the Java beans and their properties to be displayed. The application engine module 2810 coordinates with the adapter class module 2840 and the Java beans module 2850 to draw the graphical user interface for displaying the data. The event from the Java beans are centrally handled by the application engine module 2810. The configuration and state details are obtained from config.xml and state.xml files, respectively.

All requests from the client to the EMS server are channeled through the web services module 2820. Each time the application engine draws a new view (consisting of Java beans), the data required for each Java bean is obtained through Web services objects. The Web services objects have information of where the EMS server is running and how to communicate with the EMS server. Based on this information, initialization and invoking of the appropriate methods to obtain the required data is performed by the web services objects.

The application engine module 2810 gets the information of what Java beans are to be displayed and their respective properties from an XML file. For example, when an application is initiated, the first graphical user interface screen that is displayed is defined in a login.xml file. Similarly, when a user moves between screens, the respective XML file will provide the details required for that view. These XML files are provided as the input to the rendering engine module 2830. The rendering engine module 2830 converts the XML information to understandable Java vector formats. This may be done, for example, using xerces.jar and XMLParser.java from Apache, which are freely available.

In an exemplary embodiment, the rendering engine module 2830 is a hierarchical pattern of Java objects, where each type of Java object may have one or more instances of that type of Java object. All of the information for every command in the XML file is stored in Java object format. This information is available to the application engine to make the decisions on maintaining the views and also to handle all the events that result from user interaction.

Adapter classes are the layer between the application engine and the Java beans. Each Java bean that is to be used in the application has an adapter class that is handled by the adapter class module 2840. The adapter class is extended from the base class OSSControl.java which defines the behavior of how the adapters class for different Java beans are to be developed. The adapter class holds the handle to the Java bean for which it is written and it also holds some of the bean specific information. The application engine holds the handles of these adapter classes.

Java beans are used as the building blocks of the client screens and are handled by the Java bean module 2850. The Java beans provided in the awt and swing components of Java comprises the basic graphical user interface needs. For specific needs, however, custom Java beans must be developed. The custom built Java beans are designed to behave similar to the ones provided in the Java swing library and thus, they are reusable and reconfigurable. The custom developed Java beans adhere to the strict definition of the application engine and the adapter classes.

Java beans cannot directly communicate with the web server, but can get the information through the application engine module 2810 and the adapter class module 2820. The Java beans get two types of inputs from the application engine module 2810. The first is the XML render string which will be used to configure the properties of the beans, e.g., the number of columns and names to be displayed, color, font size, etc. The second type of input is the data that is to be displayed. The beans can register with the application engine to send events, such as mouse click, double click, and the like.

Each time a new view is drawn by the application engine, the Java beans that were used to display the current screen are destroyed and no information about the previous transaction is stored. Thus, each time the Java beans are created, the creation is from scratch.

In an exemplary embodiment, the Java beans that are utilized may include, for example, AlarmBeans, CrossConnectBeans, EquipmentBeans, PropertyBeans, ToolBarBeans, TopologyBeans, and the like. The AlarmBeans display all the alarms from different network elements. The AlarmBeans are capable of displaying different Alarm categories (e.g., Major, Minor, Critical, Warning, etc.) in different ways, such as in different colors, different text font, blinking, emitting a sound, etc.

The CrossConnectBean displays how the different ports of the equipment are utilized, i.e. if there are any cross connects configured, they will be displayed. This bean is also capable of performing a cross connection on request by the user.

The EquipmentBean displays the card layout for a selected device from a particular site. It also shows the alarm status and property view for each card selected. The alarm view (obtained from the AlarmBean) may be accessed from the EquipmentBean display.

The PropertyBean displays the properties for each CellPack in the equipment. It consists of the Property Name and the respective Property Value displayed in the application.

The ToolBarBean displays text buttons/icons. The ToolBarBean is used to navigate between different screens. The ToolBarBean also allows for the display of icons in each of the buttons on the toolbar.

The TopologyBean displays various network sites with different devices within the sites. Each devices can have a different state. Depending upon the state of the device, the background may blink or otherwise indicate any alarms that are raised. Through the TopologyBean, the user can drag devices and place them on any location of the network map displayed by the TopologyBean.

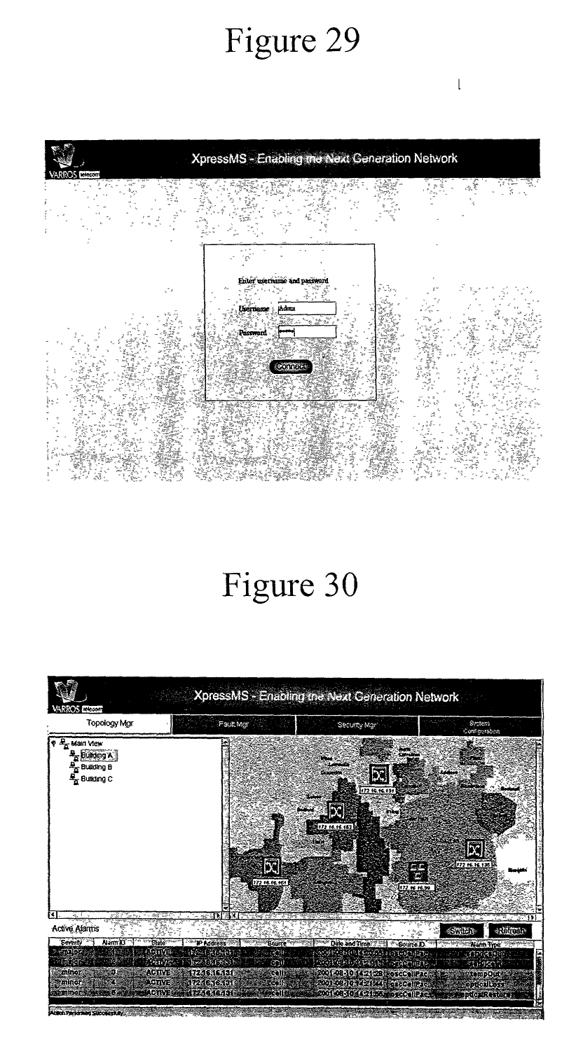

FIGS. 29-33 illustrate exemplary views generated using the Java beans discussed above. It should be appreciated that the views shown in FIGS. 29-33 are only exemplary and are not intended to imply any limitation on the types of views that may be used with the present invention. One of the many advantages of the present invention is the ability of the user to define different customized views based on the user modification of Java beans rather than having to change the application engine. Thus, the customizability of the present invention is an important feature that should be appreciated in view of the examples shown in FIGS. 2933.

FIG. 29 illustrates a login view through which a system administrator may gain access to the EMS. As shown in FIG. 29, the login view provides an interface through which a user may enter their username and password and thereby, be authenticated for access to the EMS.

FIG. 30 is a topology view that is generated using the TopologyBean described above. The topology view shown in FIG. 30 provides a map identifying the relative positions of the network equipment being monitored by the EMS. The particular view shown in FIG. 30 is a geographical view, although the present invention is not limited to such.

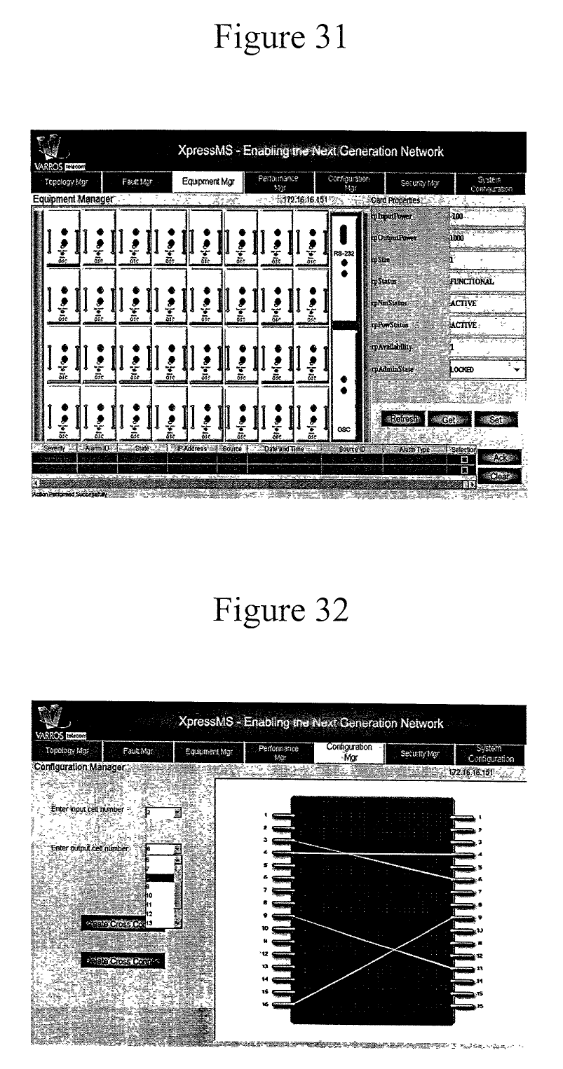

FIG. 31 is an exemplary equipment view generated using the EquipementBean discussed above. As shown in FIG. 31, the equipment view illustrates the equipment cards along with the equipment statuses. The equipment view includes a portion for management of the equipment and a portion for detailing the equipment card properties.

FIG. 32 shows a cross connect view generated using the CrossConnectBean discussed above. As shown in FIG. 32, cross connections are illustrated by cells having lines connecting them. It should be noted that a “create cross connect” button and “delete cross connect” button are provided to allow the user to generate or delete cross connections.

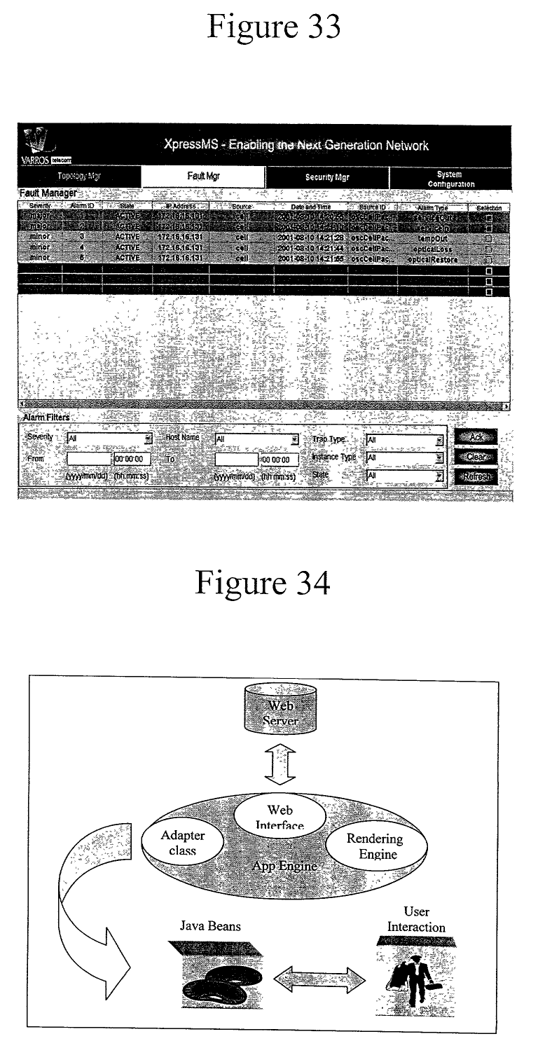

FIG. 33 is an alarm view that is generated using the AlarmBean described previously. As shown in FIG. 33, this exemplary alarm view includes a table of alarms in which identification information is provided. The identification information may include, for example, the severity of the alarm, the status of the equipment, IP address, alarm ID, source of the alarm, date and time stamp, the ID of the source, the alarm type, and the like.

It should be noted that two or more of the views shown in FIGS. 29-33 may be combined and the views may be otherwise modified such that customized views may be generated. Such customization may be performed simply by the user defining a new view through the invoking of different Java beans or modifying the Java beans to generate a new view. For example, as shown in FIGS. 30 and 31, the alarm view is combined with the topology view and the equipment view.

In summary, as shown in FIG. 34, the application engine 3410 communicates with the EMS server 3420 via the web interface 3420. The rendering engine 3430 extracts the necessary information for displaying EMS data from XML files and applies that information to Java beans 3450 via the adapter class 3440. The user may then interact with the displayed views via the Java beans 3450. Thus, by modifying the Java beans 3450 used to provide a display, the user may quickly generate new views without having to modify the application engine 3410.

In addition, the user may generate events through manipulation of interfaces provided by the Java beans 3450. That is, the user may press virtual buttons, select elements of the displayed view, operate pull down or pop-up menus, etc., by manipulating elements of the displayed view and the Java beans 3450 will identify the manipulation by the user as various events that are processed by the application engine 3410. In this way, a fully customized and interactive display is generated and used.

Because the displayed views are generated using Java beans that are defined and organized into views by the user, no modification of the application engine is necessary. Thus, the presentation of the EMS data is separated from the processing of the EMS data. As a result, the presentations may be quickly and easily modified to the desires of the individual user.

Thus, the present invention provides a highly customizable EMS. The present invention provides a mechanism by which network elements for use with the EMS may be quickly and easily defined using existing base network element models. The business logic and element specific functions are separated out by a data channel such that each may be modified independently of the other. In addition, presentation screens may be modified independent of the network services and equipment in the EMS such that a modification to one part of the EMS does not require modification of all other parts of the EMS.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of customizing an element management system, comprising:
generating a customized model representing a network element from a base model;
generating a data channel for the customized model;
providing a protocol adapter for the customized model; and
plugging the customized model into a software bus by way of the protocol adapter and the data channel.

2. The method of claim 1, wherein the base model is a generic representation of a type of network device, and wherein the customized model is a specific representation of a vendor specific instance of the network device.

3. The method of claim 1, wherein the base model is a model information base.

4. The method of claim 1, wherein generating a data channel includes modifying a base data channel based on functionality of the customized model.

5. The method of claim 1, wherein generating a customized model representing a network element from a base model includes compiling an information model into an XML/NMI instance file.

6. The method of claim 5, wherein generating a data channel further includes incorporating the data channel into the XML/NMI instance file.

7. The method of claim 5, wherein providing a protocol adapter includes:
determining a protocol used by the network element; and
incorporating a protocol adapter that performs conversion of messages from the protocol used by the network element to a protocol used by an element management system framework.

8. The method of claim 1, further comprising:
defining a presentation screen; and
linking the presentation screen with a network service, wherein the presentation screen is used to view information obtained from the network element.

9. The method of claim 1, wherein the base model and customized model make use of the Universal Modeling Language.

10. The method of claim 1, further comprising customizing business logic associated with the customized model.

11. The method of claim 10, wherein customizing the business logic includes:
defining the business logic in the Action Language; and
compiling the Action Language into executable code.

12. An apparatus for customizing an element management system, comprising:
means for generating a customized model representing a network element from a base model;
means for generating a data channel for the customized model;
means for providing a protocol adapter for the customized model; and
means for plugging the customized model into a software bus by way of the protocol adapter and the data channel.

13. The apparatus of claim 12, wherein the base model is a generic representation of a type of network device, and wherein the customized model is a specific representation of a vendor specific instance of the network device.

14. The apparatus of claim 12, wherein the base model is a model information base.

15. The apparatus of claim 12, wherein the means for generating a data channel includes means for modifying a base data channel based on functionality of the customized model.

16. The apparatus of claim 12, wherein the means for generating a customized model representing a network element from a base model includes means for compiling an information model into an XML/NMI instance file.

17. The apparatus of claim 16, wherein the means for generating a data channel further includes means for incorporating the data channel into the XML/NMI instance file.

18. The apparatus of claim 16, wherein the means for providing a protocol adapter includes:
means for determining a protocol used by the network element; and
means for incorporating a protocol adapter that performs conversion of messages from the protocol used by the network element to a protocol used by an element management system framework.

19. The apparatus of claim 12, further comprising:
means for defining a presentation screen; and
means for linking the presentation screen with a network service, wherein the presentation screen is used to view information obtained from the network element.

20. The apparatus of claim 12, wherein the base model and customized model make use of the Universal Modeling Language.

21. The apparatus of claim 12, further comprising means for customizing business logic associated with the customized model.

22. The apparatus of claim 21, wherein the means for customizing the business logic includes:
means for defining the business logic in the Action Language; and
means for compiling the Action Language into executable code.

23. A computer program product in a computer readable medium for customizing an element management system, comprising:
first instructions for generating a customized model representing a network element from a base model;
second instructions for generating a data channel for the customized model;
third instructions for providing a protocol adapter for the customized model; and
fourth instructions for plugging the customized model into a software bus by way of the protocol adapter and the data channel.

24. The computer program product of claim 23, wherein the base model is a generic representation of a type of network device, and wherein the customized model is a specific representation of a vendor specific instance of the network device.

25. The computer program product of claim 23, wherein the base model is a model information base.

26. The computer program product of claim 23, wherein the second instructions for generating a data channel include instructions for modifying a base data channel based on functionality of the customized model.

27. The computer program product of claim 23, wherein the first instructions for generating a customized model representing a network element from a base model include instructions for compiling an information model into an XML/NMI instance file.

28. The computer program product of claim 27, wherein the second instructions for generating a data channel further include instructions for incorporating the data channel into the XML/NMI instance file.

29. The computer program product of claim 27, wherein the third instructions for providing a protocol adapter includes:
instructions for determining a protocol used by the network element; and
instructions for incorporating a protocol adapter that performs conversion of messages from the protocol used by the network element to a protocol used by an element management system framework.

30. The computer program product of claim 23, further comprising:
fifth instructions for defining a presentation screen; and
sixth instructions for linking the presentation screen with a network service, wherein the presentation screen is used to view information obtained from the network element.

31. The computer program product of claim 23, wherein the base model and customized model make use of the Universal Modeling Language.

32. The computer program product of claim 23, further comprising fifth instructions for customizing business logic associated with the customized model.

33. The computer program product of claim 32, wherein the fifth instructions for customizing the business logic includes:
instructions for defining the business logic in the Action Language; and
instructions for compiling the Action Language into executable code.

34. The method of claim 8, wherein defining a presentation screen includes:
generating a XML/UIL file defining the presentation screen; and
rendering the presentation screen by processing the XML/UIL file.

35. The method of claim 34, wherein rendering the presentation screen by processing the XML/UIL file includes:
instantiating one or more Java beans based on instructions obtained from the XML/UIL file.

36. The method of claim 35, wherein the one or more Java beans include application program logic for capturing and acting upon user events associated with one or more elements of the presentation screen, the one or more elements of the presentation screen being associated with the one or more Java beans.

37. The apparatus of claim 19, wherein the means for defining a presentation screen includes:
means for generating a XML/UIL file defining the presentation screen; and
means for rendering the presentation screen by processing the XML/UIL file.

38. The apparatus of claim 37, wherein the means for rendering the presentation screen by processing the XML/UIL file includes:
means for instantiating one or more Java beans based on instructions obtained from the XML/UIL file.

39. The apparatus of claim 38, wherein the one or more Java beans include application program logic for capturing and acting upon user events associated with one or more elements of the presentation screen, the one or more elements of the presentation screen being associated with the one or more Java beans.

40. The computer program product of claim 30, wherein the fifth instructions for defining a presentation screen include:
instructions for generating a XML/UIL file defining the presentation screen; and
instructions for rendering the presentation screen by processing the XML/UIL file.

41. The computer program product of claim 40, wherein the instructions for rendering the presentation screen by processing the XML/UIL file include:
instructions for instantiating one or more Java beans based on instructions obtained from the XML/UIL file.

42. The computer program product of claim 41, wherein the one or more Java beans include application program logic for capturing and acting upon user events associated with one or more elements of the presentation screen, the one or more elements of the presentation screen being associated with the one or more Java beans.
